(19) United States
(12) Patent Application Publication
(10) Pub. No.: US 2002/0026365 A1
(43) Pub. Date: Feb. 28, 2002

(54) Method and system for electronic payment and check guarantee

(76) Inventor: Rony Natanzon, Baltimore, MD (US)

Correspondence Address: Adam K Sacharoff, Hamman & Benn, 10 South LaSalle Street, Chicago, IL, 60603, US

(21) Appl. No.: 09/934,750

(22) Filed: Aug. 22, 2001

Related U.S. Application Data
(60) Provisional application No. 60/228,846, filed on Aug. 29, 2000.

(51) Int. Cl. G06F 17/60; G06G 1/12

(52) U.S. Cl. 705/16; 705/17

(57) ABSTRACT

One method of the present invention includes presenting a prepared bank check, in relation to a point-of-sale transaction, to the merchant. The merchant, using a point-of-sale terminal, scans the prepared bank check to retrieve consumer bank account information and using the terminal may enter transaction information. The information is then transmitted to a third party's central database for authorization or rejection of the check transaction. The third party may thereafter present the information to an originating depository financial institution for electronic settlement. The merchant further retains the paper check and forwards it to the third party to secure the electronic settlement. If the consumer cancels the electronic settlement in bad faith, the third party may thereafter present the paper check as a negotiable instrument to the originating depository financial institution.

### CROSS REFERENCE TO RELATED APPLICATIONS

This application claims the benefit of U.S. Provisional Patent Application Ser. No. 60/228,846 and filed on Aug. 29, 2000 and U.S. Provisional Patent Application Ser. No. 60/232,359 and filed on Sep. 14, 2000. Both provisional applications are hereby incorporated by reference.

### FIELD OF THE INVENTION

This invention relates to a method and system for an electronic payment based off of a prepared check and, more importantly, includes a method and system for an electronic payment method and system with the ability to guarantee payment of a check.

### BACKGROUND OF THE INVENTION

Numerous systems exist today for accepting checks for payment at a point-of-sale transaction. In the most rudimentary system, a check is simply accepted by a merchant from a consumer for the payment of the transaction. The merchant then at a later date presents the check to his bank for processing and settlement. However, until the check maker's bank processes and pays the check, the merchant cannot know if he will be paid by his bank for that check. For example, the consumer may stop payment, the account may be closed, frozen or may not contain sufficient funds to settle the transaction or the check may be forged. Thus, merchants are more inclined to refuse payment by checks.

In yet other systems, the check is provided to the merchant briefly to authorize an electronic transfer of funds from the consumer's bank account. The check is placed through a Magnetic Ink Character Recognition (“MICR”) reader, where the MICR number information on the check is read or scanned, providing sufficient information to identify the consumer's bank account and routing number. The consumer's bank account information, along with various transaction information, is then transmitted to an Automated Clearing House for subsequent electronic settlement. Such a system may be found in U.S. Pat. Nos. 5,484,988 and 6,164,528 both issued to Hills et al. As further disclosed by the Hills' patents, the check is never used as a negotiable instrument as it is voided after it is placed through the MICR reader. Moreover, the check is returned to the consumer after the necessary information has been captured.

Unfortunately, the merchant cannot be certain that the consumer will honor the electronic transfer once the point-of-sale transaction is complete, since the electronic transfer will not occur until after the point-of-sale transaction and because the consumer has up to 60 days in which to revoke the electronic transfer through his financial institution. As such, a need still exists that increases the merchant's confidence when accepting bank checks, either as electronic debit items or paper checks for payment of goods or services.

### SUMMARY OF THE INVENTION

A method and system for settling and guaranteeing a point-of-sale check transaction between a consumer and a merchant is provided in accordance with the present invention. The method of the present invention includes presenting a prepared paper bank check, in relation to a point-of-sale transaction, to the merchant. The merchant, using a point-of-sale MICR reader, scans the prepared bank check to retrieve consumer bank account information and provides transaction information in relation to the point-of-sale transaction. The point-of-sale MICR reader may create a scanned image of the check or simply retrieve the transaction information. The merchant obtains authorization to electronically debit the consumer's checking account through point-of-sale signage or written consent from the consumer. The transaction information is then transmitted to a third party. Based on the consumer's authorization, the third party may thereafter electronically present the information to an originating depository financial institution, instructing the institution to deduct funds from the consumer's checking account. The third party separately credits the merchant's account for the transaction. The merchant further retains the paper check and forwards it to the third party to guarantee the electronic settlement in the event that the electronic debit item returns unpaid.

To guarantee the electronic debit item, the check is held as a negotiable instrument and presented to a bank if and when the consumer revokes the electronic settlement in bad faith. When a scanned image is created and forwarded to the central database, the scanned image may also be held as a negotiable instrument and presented to the bank.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is an overall system schematic of the present invention;

FIG. 2 is a preferred method of the present invention; and

FIG. 3 is a perspective illustration of a point-of-sale terminal incorporating all of the major components to conduct a point-of-sale transaction in accordance with the present invention by accepting various means of settling the transaction including, but not limited to, credit cards, debit cards and checks.

### DETAILED DESCRIPTION OF THE DRAWINGS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

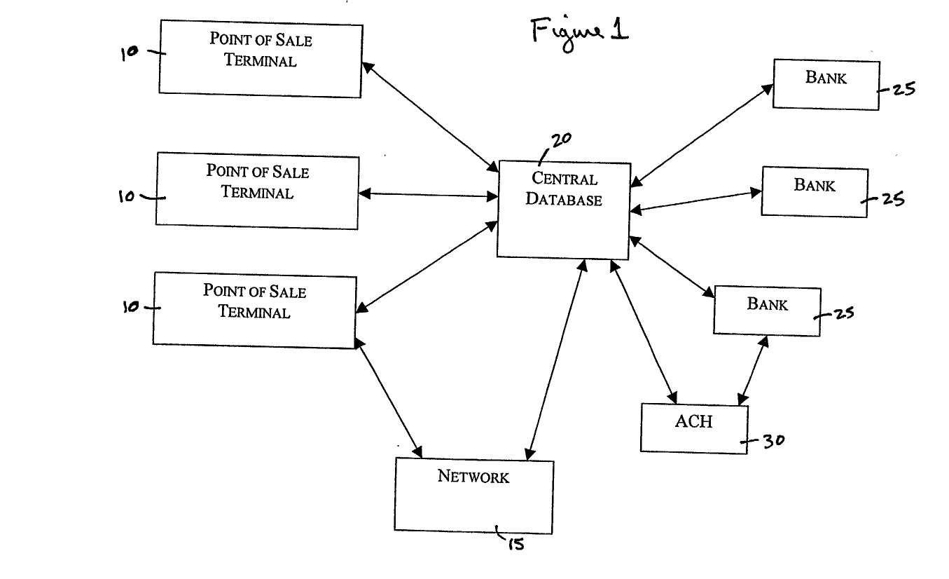

Referring now to FIG. 1, an overall system schematic of the present invention is described. The system includes a plurality of point-of-sale terminals 10, set up to accept point-of-sale transactions. As described in greater detail below, the point-of-sale terminals 10 are capable of reading credit/debit cards and capable of reading and/or scanning checks. Each point-of-sale terminal 10 can communicate with a network 15 for proper authorization of the credit/debit card. The point-of-sale terminals 10 are also in communication with a third party's central database 20, which may be used to authorize or reject consumer check transactions. The third party 20, discussed in greater detail below, communicates with an originating depository financial institution 25 in order to process electronic fund transfers. The third party 20, as well as the originating depository financial institution, 25 may be further in communication with an Automated Clearing House (“ACH”), for the processing of the electronic transfers. However, it is important to note that in a system where an ACH is not present or necessary, the third party 20 may process and clear transactions with depository financial institutions 25 themselves.

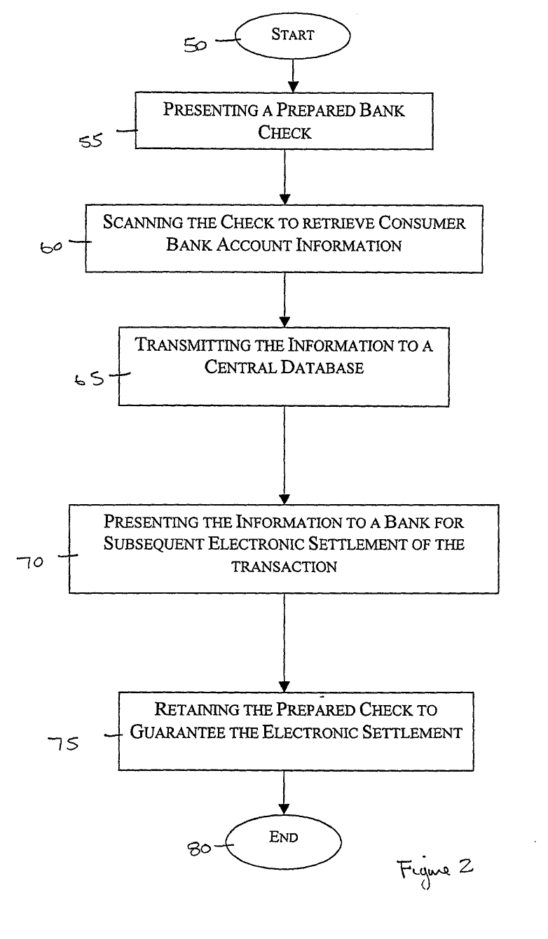

Referring now to FIG. 2, a process for an electronic payment based off of a prepared check for a point-of-sale transaction between a consumer and merchant and a method for guaranteeing the electronic payment is illustrated. The method starts at step 50, where a consumer presents a prepared bank check to the merchant for the point-of-sale transaction, step 55. The merchant then scans the presented check to retrieve consumer bank account information, step 60.

Step 60 is preferably conducted using the point-of-sale terminal 10. In one embodiment, the point-of-sale terminal 10 includes an image scanner, which scans the check creating a scanned image of the check. In another embodiment, the point-of-sale terminal 10 scans pertinent information from the check, by reading the Magnetic Ink Character Recognition number information. Additional information such as the sale amount, Merchant ID Number, check number, etc., may either be retrieved from the check or entered into the point-of-sale terminal 10. The information as well as the scanned image is then transmitted from the point-of-sale terminal 10 to a third party 20 located off premises from the point-of-sale terminal 10, step 65. It is conceived by the present invention that when transmitting the information is not possible via the check reader, the information may be retrieved by the merchant and called into a third party operating the central database via telephone or facsimile.

After the transaction information is received by the third party, the information is verified by a database operated by the third party, step 67. The database attempts to match the account information against a negative file of previous unpaid checks. If the account information can be matched to a previously unpaid check on the check writer's account, then the database automatically returns a declined transaction message to the merchant via the point-of-sale terminal. Conversely, if the account information cannot be matched to a previously unpaid check on the check writer's account, then the database automatically returns an approval message of an authorized transaction to the merchant via the point-of-sale terminal.

Following an authorized transaction at step 67, the information may now be presented to an originating depository financial institution for subsequent electronic settlement, step 70. Since the third party 20 is in communication with an originating depository financial institution 25 or an Automated Clearing House 30, an electronic transfer of funds is possible from the consumer's bank account to either the merchant's bank account or to the third party's bank account operating the central database. When the funds are transferred into a third party bank account, the third party settles separately with the merchant further ensuring the merchant that the funds will be available for the transaction. However, since the consumer is still afforded with the right to revoke the electronic transfer, a further step is needed to guarantee the electronic settlement, step 75.

When a consumer revokes an electronic transfer, the consumer's bank will credit the finds back into the consumer account and withdraw the funds from the originating depository financial institution. The originating depository financial institution, in turn, will deduct such funds from the originator of the transfer. Since the consumer may revoke an electronic transfer up to 60 days after the transfer took place, it is contemplated that the consumer may do so in bad faith, meaning the consumer may receive goods or services without properly paying for the transaction.

In accordance with the present invention and to protect the merchant from any bad faith on the part of a consumer, the merchant retains the prepared check as a negotiable instrument after the transaction is complete and forwards the check to the third party operating the central database. If the consumer cancels the transfer in bad faith thereafter, the third party having retained the check, may present the check as a negotiable instrument to the bank through normal banking procedures. In addition, to protect the consumer in case the merchant fails to relinquish the check to the third party, the third party will cover any expenses owed to the consumer arising out of bad faith on the part of the merchant.

Continuing to refer to FIG. 2, additional embodiments are now discussed in greater detail. As stated above, the point-of-sale terminal 10 may include an image scanner. In such instances, the scanned image is transmitted to the central database 20 and stored on file on a storage means. When the consumer cancels an electronic transfer in bad faith, the third party may present to the bank the scanned image of the check to the bank as a negotiable instrument for settlement thereon. As such, the actual paper check may be returned to the consumer after the point-of-sale transaction, appropriately stamped indicating a scanned image of the check has been retained for purposes of presentment in case of fraud, or the paper check may be retained in a lockbox for protection. Additionally, when the check is retained by the merchant and sent to the third party operating the central database, the check may also be stamped at the end of the transaction. Such stamp may indicate that payment was made by electronic settlement and that the check is retained for purposes of presentment in case of fraud.

Prior to presenting the information to a bank for subsequent electronic settlement of the transaction, the merchant may be required to obtain authorization from the consumer to conduct an electronic transfer. As such, a written authorization form may be printed on the back of the check or on a separate receipt. The authorization might also be forwarded to the third party to ensure proper authorization was obtained from the consumer.

The third party 20 may also conduct a separate authorization and validation of the transaction prior to transmitting the information to the bank 25. The third party 20, having access to a consumer database, may compare the check information or consumer bank account information against that database to determine if the transaction should be authorized. For example. if the consumer has previously written a bad check or is known to have previously cancelled an electronic transaction in bad faith, the third party 20 will alert the merchant, via the point-of-sale terminal, that the check cannot be guaranteed for payment. Thereafter, the merchant may accept the check for payment of the transaction without the added confidence that the check will ultimately be paid.

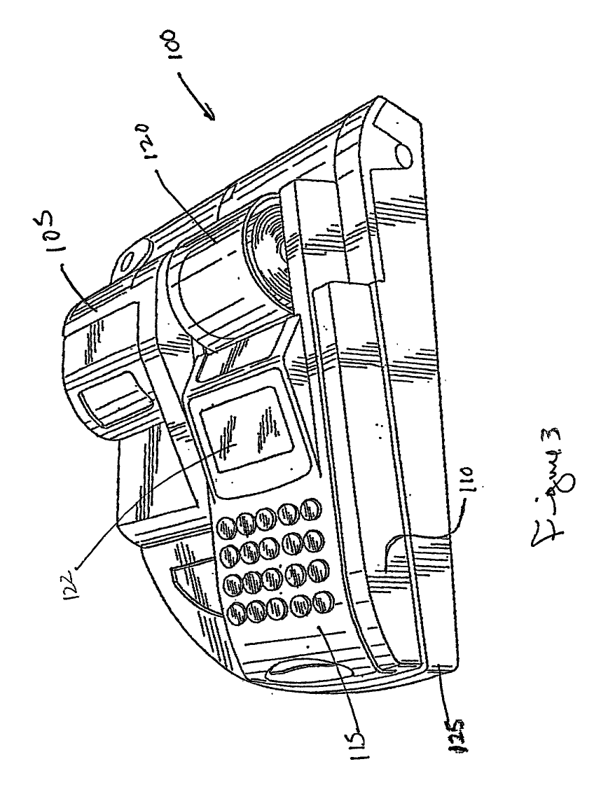

In another embodiment of the present invention, a point-of-sale terminal is provided that includes all of the necessary components to conduct the transaction and transmit the information to the central database. Referring now to FIG. 3, a point-of-sale terminal is illustrated and generally referenced to as 100. The terminal 100 includes a check reader 105, a credit/debit card reader 110, a keypad 115, a tape receipt 120 and a display 122. These components are attached to a single swivel base 125. A PCB board (not shown) permits the aforementioned components to communicate and connect with each other. Moreover, the PCB board may contain memory and storage capabilities to permit the communication with various networks, the central computer, data servers and directly with banks. The terminal may also include an image scanner, such that a check fed through the check reader would be scanned and an image created.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed:

1. A process for settling and guaranteeing a point-of-sale transaction between a consumer and a merchant comprising:
presenting a prepared bank check, in relation to a point-of-sale transaction, to the merchant;
scanning the prepared bank check with a point-of-sale terminal located at the point-of-sale transaction, creating a scanned image of the prepared bank check;
transmitting the scanned image of the prepared bank check and transmitting transaction information to a central database from the point-of-sale terminal; and
obtaining consumer bank account information from the scanned image of the prepared bank check;
submitting the consumer bank account information and transaction information to a originating depository financial institution for subsequent electronic settlement.

2. The process of claim 1 further comprising:
obtaining authorization from the consumer for the electronic settlement.

3. The process of claim 1 further comprising:
storing the scanned image of the prepared bank check on a storing means to guarantee the electronic settlement.

4. The process of claim 3 wherein the step of storing the scanned image of the prepared bank check to guarantee the electronic settlement further includes the step of presenting the scanned image of the prepared bank check as a negotiable instrument to the bank, when the consumer revokes the electronic settlement in bad faith or the electronic settlement returns unpaid.

5. A system to electronically settle and guarantee a point-of-sale transaction between a consumer and a merchant comprising:
a point-of-sale terminal, located at the point-of-sale transaction, to receive a prepared bank check, in relation to the point-of-sale transaction, the point-of-sale terminal configured to retrieve consumer bank account information and transaction information in relation to the point-of-sale transaction from the prepared bank check;
a third party's central database in communication with the point-of-sale terminal set up terminal to receive said consumer bank account information and transaction information in relation to the point-of-sale transaction;
the third party having a means to validate and authorize the transaction based upon said consumer bank account information and transaction information, wherein the central database transmits a validation code to the point-of-sale terminal authorizing the transaction; and
the third party instructing an originating depositary financial institution to transmit said consumer bank account information and transaction information for subsequent electronic settlement of the point-of-sale transaction.

6. The system of claim 5, wherein upon receipt of the validation code authorizing the transaction, the merchant retains the prepared check to guarantee the electronic settlement whereupon the consumer cancels the transaction in bad faith.

7. The system of claim 6, wherein when the consumer cancels the transaction in bad faith, the prepared check is submitted to the bank as a negotiable instrument for settlement of the transaction.

8. A process for settling and guaranteeing a point-of-sale transaction between a consumer and a merchant comprising:
presenting a prepared bank check, in relation to a point-of-sale transaction, to the merchant;
scanning the prepared bank check, by a point-of-sale terminal, to retrieve consumer bank account information
transmitting the consumer bank account information and transaction information to a central database for subsequent electronic settlement of the point-of-sale transaction; and
retaining the prepared bank check as a negotiable instrument to guarantee the electronic settlement when the consumer revokes the electronic settlement in bad faith or the electronic settlement returns unpaid.

9. The process of claim 8, wherein the step of retaining the prepared bank check to guarantee the electronic settlement includes presenting the check to the bank as a negotiable instrument when the consumer cancels the electronic settlement in bad faith.

10. The process of claim 9, wherein the step of transmitting the consumer bank account information and transaction information to a central database for subsequent electronic settlement includes the step of authorizing or validating the transaction.

11. The process of claim 10, wherein the step of authorizing or validating the transaction includes the steps of:
examining the consumer bank account information to determine whether the transaction is approved or denied; and
transmitting an authorization or validation code back to the point-of-sale terminal in relation to the approval or denial of the transaction.

12. The process of claim 8 further comprising obtaining authorization from the consumer for electronic settlement of the transaction;

13. A system to electronically settle and guarantee a point-of-sale transaction between a merchant and a consumer comprising:
a point-of-sale terminal configured to read consumer bank account information from a prepared bank check, the point-of-sale terminal also configured to receive transaction information in relation to the point-of-sale transaction;
a central database;
a means for transmitting said consumer bank account information and transaction information from the point-of-sale terminal to the central database;
the central database including the means for receiving said consumer bank account information and transaction information from the point-of-sale terminal and, further including the means for validating and authorizing an electronic settlement of the point-of-sale transaction, the central database further including the means to transmit to the point-of-sale terminal a denial or acceptance based off of the means for validating and authorizing the electronic settlement;
the point-of-sale terminal, upon receiving the acceptance from the central database, further includes the means to display said acceptance, whereupon the prepared bank check is retained as a negotiable instrument by the merchant for subsequent presentment when the consumer revokes the electronic settlement in bad faith or the electronic settlement returns unpaid; and
a third party with the means to transmit said consumer bank account information and transaction information to an originating depository financial institution for subsequent electronic settlement of the point-of-sale transaction.

14. The system of claim 13, wherein the point-of-sale terminal is configured to scan the prepared check to create a scanned image of said prepared check.

15. The system of claim 14, wherein the scanned image of the prepared check is transmitted to the central database, the central database further including the means to store said scanned image such that when the consumer cancels the electronic settlement in bad faith the scanned image is presented to the bank as an negotiable instrument for settlement thereof.

16. A point-of-sale terminal comprising:
a means for scanning a check prepared for electronic settlement of a transaction between a merchant and a consumer and for creating a scanned image of said prepared check;
a means to communicate with a central database operated by a third party for transmitting the scanned image of said prepared check such that when a consumer revokes the electronic settlement in bad faith said scanned image may be submitted to a bank as a negotiable instrument for settlement of the transaction;
a means for reading a magnetic strip of a credit card or debit card and the accessing information embedded is such magnetic strip;
a keypad means for entering transaction information and pin code information;
a means for displaying various transaction information and for displaying various validation or authorization information; and
a housing supporting the scanning means; reading means, keypad means and display means.

17. The point-of-sale terminal of claim 16 further comprising:
a means to scan Magnetic Ink Character Recognition information from the prepared check to transmit said information on said communication means to a central database for subsequent electronic settlement.
